(19) United States
(12) Patent Application Publication
(10) Pub. No.: US 2007/0192125 A1
(43) Pub. Date: Aug. 16, 2007

(54) Method of transmitting update data for a stock market order book

(76) Inventor: Patrice Porte, Paris (FR)

Correspondence Address: BLANK ROME LLP, 600 NEW HAMPSHIRE AVENUE, N.W., WASHINGTON, DC, 20037, US

(21) Appl. No.: 11/643,692

(22) Filed: Dec. 22, 2006

(30) Foreign Application Priority Data
Dec. 22, 2005 (FR) 0513147

(51) Int. Cl. G06Q 10/00

(52) U.S. Cl. 705/1

(57) ABSTRACT

The invention relates to a method of remotely updating an original order book comprising order data indexed according to at least one parameter stored in a distribution server. The method includes the steps of the distribution server receiving update data, the update data comprising at least one attribute of at least one parameter and comparing the update data with at least part of the original order book. The method further includes identifying, according to the comparison, at least one index of the at least one attribute of the update data, as well as a first action relating to the original order book at the index level and transmitting the index to at least one client workstation, as well as the first action relating to the original order book at the index level.

### FIELD OF THE INVENTION

The present invention relates to the field of methods of transmitting data, in particular in the stock market field.

### BACKGROUND OF THE INVENTION

In the field of stock market data transmission, it is known to use a three-level architecture as shown in FIG. 1, comprising a stock market 1, a distribution server 2 transmitting public data from the stock market 1 to the subscriber clients 3a, 3b, 3c.

In order for the clients 3a, 3b, 3c to be able to react as quickly as possible to fluctuations of the stock market 1, it is important for the distribution server 2 to transmit the update data emerging from the stock market in a quick, efficient and integral fashion.

When the distribution server contains an original order book in a first instant t, and the stock market issues data to update the order book in the instant t+1, it is necessary to send, as soon as possible, the new order book obtained by updating the original order book.

An order book 4 has, in a known fashion, of a double list of purchases and sales as shown in FIG. 2.

A first known solution provides for the updating of the order book in the distribution server with a view to generating an updated order book, and then sending this entire updated order book to the clients 3a, 3b, 3c.

This method has the disadvantage of requiring the transmission of the entire order book, which corresponds to a considerable transmission of data and, therefore, to a considerable transfer time.

This transfer time is sometimes incompatible with the real-time processing requirements of clients 3a, 3b, 3c.

One of the aims of the present invention is therefore to maintain an order book updated in the clients' 3a, 3b, 3c workstation while avoiding the transmission of all the data in the updated order book.

Patent application FR-2 755 559 describes, in particular, a method of transmitting updated data from a central server to at least one subscriber workstation, by means of a digital communication network in which each subscriber can connect his/her workstation to a server. The method of transmitting updated data comprises a step of comparing the previously stored data with the transmitted data and, in particular, a step of saving the transmitted data instead of the stored data only when they are different.

The method described in patent application FR-2 755 559 particularly enables cost reductions, since only the different data are saved in the memory of the client workstation, in contrast to saving all the data transmitted replacing the data stored in accordance with the previously mentioned method.

The invention relates to a method that makes it possible further to reduce the costs and increase the security of the transmission by minimising the amount of data transmitted and by maintaining an organised order book on the client workstations.

### SUMMARY OF THE INVENTION

This aim is achieved according to one aspect of the invention by a method of remotely updating an original order book comprising order data indexed according to at least one parameter stored in a distribution server. The method includes receiving update data including at least one parameter attribute in the distribution server. Then, according to the method, the next step consists of comparing the update data with at least part of the original order book and identifying, according to the comparison, at least one index of the attribute of the update data, as well as a first action regarding the original order at index level. Finally, the method comprises transmitting the index and the first action relating to the original order at index level to at least one client workstation.

When performed in this way, the method according to the invention makes it possible only to transmit the data that has changed, unlike the method described in the French patent application mentioned above, which transmitted all the data and only saved the data that had been modified in the client workstation.

The embodiment of the method according to the invention is possible in particular thanks to the presence of the indexes. Indeed, according to the method set out in the invention, the comparison of the indexes is what makes it possible to identify the data that have been modified, and thereby to enable the selection of the modified data only in order to transmit them alone.

The first action is preferably determined from among deletion, insertion or modification in the original order book.

The parameter corresponds, for example, to the sale or purchase price and makes it possible to index the order book, each line of the book corresponding to a unique index.

According to a first embodiment of the invention, the update data comprise at least one data element relating to a second update action associated with the attribute of the parameter, the first action relating to the original order at index level being identical to the second action.

In this case, update data are received, for example, in the form of an insertion order at a given price corresponding to the second update action. According to the invention, the index at which this insertion should take place is then determined, and this index as well as the order for insertion at the level of this index are transmitted to the client. According to the invention, if an insertion order is received, this same type of insertion action is transmitted to the client.

According to a second embodiment of the invention, the update data comprise an updated order book, the first action relating to the original order book at index level being determined by the difference between the updated order book and the original order book.

In this case, the stock market transmits data in the form of an image that directly corresponds to the updated order book. This updated order book is then received by the distribution server. In this case, the updated attributes are compared with the attributes of the original order book in order to determine the differences, and the differences, the actions, for example such as insertion, modification or deletion, associated with the differences are deduced. These differences then form an action at index level that will be transmitted to the client workstations.

### BRIEF DESCRIPTION OF THE FIGURES

The invention will be understood better from reading the description, provided below for purely explanatory reasons, of an embodiment of the invention, made in relation to the appended figures, in which:

FIG. 1 shows a known distribution architecture between a stock market and a plurality of clients according to the prior art;

FIG. 2 shows an example of the structure of a known order book, stored in a distribution server;

FIG. 3 shows an example of an embodiment of the method according to the invention according to a first embodiment thereof;

FIG. 4 shows an example of an embodiment of the method according to the invention according to a second embodiment thereof;

FIG. 5 shows a first example of update data 5 received by the distribution server, which will be processed according to a first embodiment of the invention; and

FIG. 6 shows update data received by the distribution server.

### PREFERRED EMBODIMENT OF THE INVENTION

The following terms are defined in the framework of the present application:

A “stock market operation by differential” relates to a line update, insertion or deletion.

A “stock market operation by image” relates to the reception of an updated order book image.

It is also understood that, according to the present application, the transmissions between different computer stations can be carried out by a transmission network. In particular, the transmissions between the stock market and the distribution server are preferably carried out by a data transmission network, and the transmissions between the distribution server and the client workstations are preferably carried out by a data transmission network.

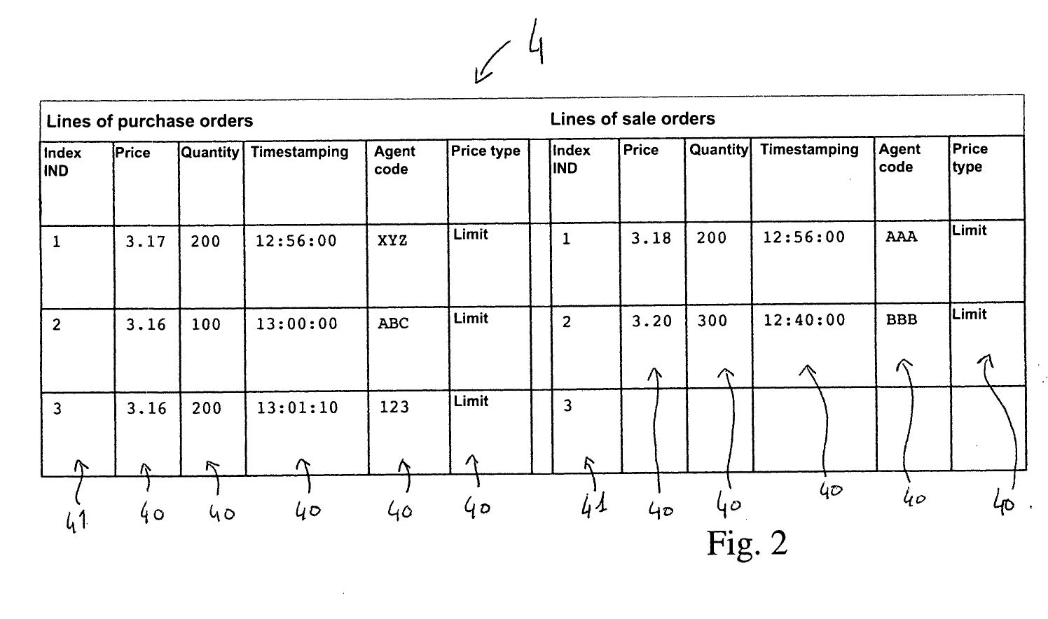

FIG. 2 shows an order book 4 of a known type comprising attributes, for example the following attributes:

“Quantity”

“Price”

“Timestamping”

“Agent code”

“Price type”

It also comprises lines made up of attributes 40.

It is also possible to define a “Key” parameter corresponding to a series of attributes that make it possible to define a line in a unique fashion.

The index 41 of line 1 , 2, 3, . . . , n corresponding to the position of the line in a series of lines is also defined.

In the field of stock market data transmission, the lines are always classified according to price and then by order of insertion. The prices are classified in ascending order for Purchases and in descending order for Sales. In the case of identical prices, they are classified in ascending order of insertion for purchases and for sales. These price attributes 40 form an indexing parameter 102 and therefore allow indexing of the order book 4. It is evident that other indexing parameters can be considered according to the invention.

The order book ultimately includes of all the purchase and sale orders.

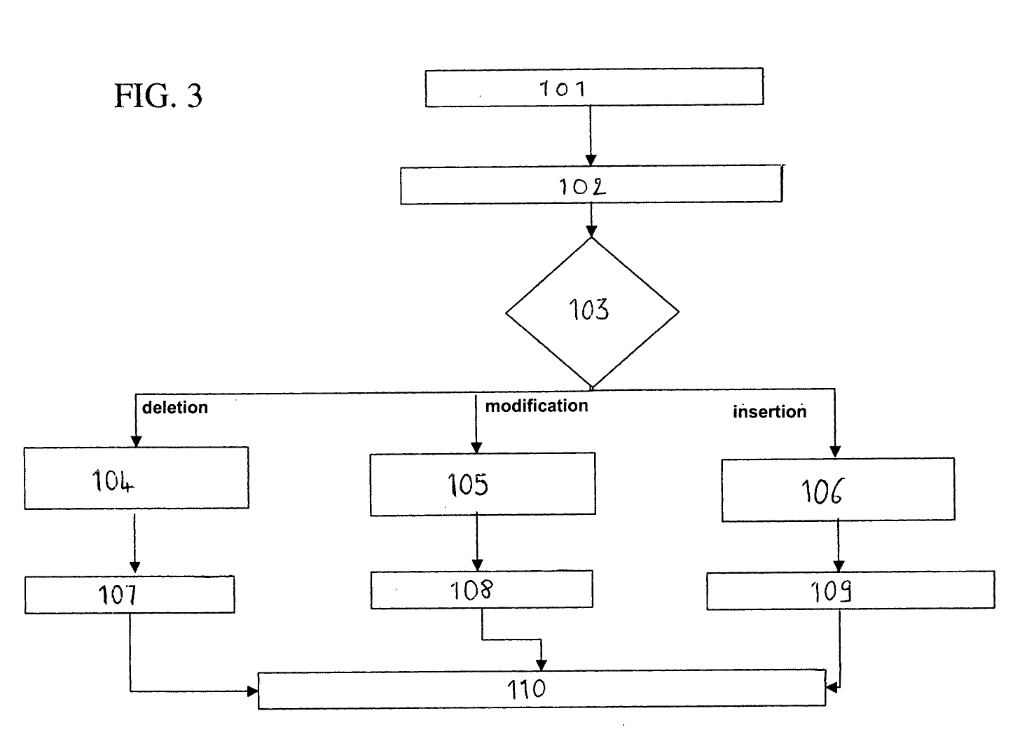

As shown in FIG. 3, according to a first embodiment of the invention, the update data correspond to a stock market operation by differential and comprise a type of action, a direction designating the Purchase and Sale lines and a series of attributes 40. The list of attributes supplied by the stock market varies according to the type of action to be applied. Some of these attributes 40 are required for the correct execution of the action and cannot be omitted:

line creation action: all the attributes 40 that constitute a line (thereby including the fields that allow the construction of the key parameter) must necessarily be supplied.

line deletion action: the attribute or attributes 40 that allow the constitution of the Key parameter must be supplied.

line modification action: the attribute or attributes 40 that allow the constitution of the Key parameter must be supplied in addition to those to be modified.

Initially, the key indexing parameter referenced by step 102 in FIG. 3 is constructed. The “Key” parameter includes of one or several attributes of a line making it possible to identify said line throughout its entire life (from its creation to its deletion, passing by its modifications). This “Key” parameter corresponds, according to the invention, to a parameter for indexing the lines of the order book.

Example of a line Key made up of three attributes:
Key {Price, Quantity, Timestamping}

Example of constructing the Key with the help of attributes:
Construct Key (Key, Price, Quantity, Timestamping)
   Key.Price=Price
Key.Quantity=Quantity
Key.Timestamping=Timestamping

Secondly, the type of action to be applied is managed according to step 103, shown in diagrammatic fashion in FIG. 3. The type of action to be applied is a line insertion, a line modification or a line deletion. A specific treatment is dedicated to each of these actions.

According to the invention, and for each of the actions mentioned above—deletion, modification, insertion—, the line corresponding to the action to be applied is searched. For this purpose, the line index is determined according to steps 104, 105 and 106, respectively for the actions of deletion, modification and insertion. The line index is determined in the list of lines for a given direction (Purchase or Sale). It is a question of reconstructing, for each of the scanned lines, a so-called “updated key”, which is then compared with the previously constructed key, called “original key”. In the framework of a deletion or modification operation, the chosen index is then the index of the line in which the key is identical to the supplied key.

In the framework of an insertion operation, the chosen index must make it possible to retain the consistency of the price classification. In the framework of a purchase limit, the limits are classified in descending order by price. When scanning the limits, starting with the first limit, the index returned will be the index of the first limit found in which the price is strictly lower than the price of the received limit. In the framework of a sale limit, the limits are classified in ascending order by price. When scanning the limits, starting with the first limit, the index returned will be the index of the first limit found in which the price is strictly higher than the price of the received limit.

The following algorithm is an example of searching for a line index using the “Key” parameter:

SearchLineIndex(Index, Key, Lines)
maxNumberIndex = Lines.NumberOfLines−1
FOR every index from 0 to maxNumberIndex

line = Lines[index]

ConstructKey(lineKey, line.Price, line.Quantity,

line.Timestamping)

IF lineKey = = Key

Return index

ENDIF

ENDFOR

Retourn NOT_FOUND

The line index is determined in the list of lines for a given direction (Purchase or Sale).

The following algorithm is an example of a line index search with the price parameter dedicated to the Purchase direction:

| | |
|---|---|
| SearchIndexForPurchaseInsertion(Index, | Price, |

Lines)

maxIndexNumber = Lines.NumberOfLines−1
FOR every index from 0 to maxIndexNumber

line = Lines[index]

IF line.price > price

Return index

ENDIF

ENDFOR

Retourn maxIndexNumber+1

The following algorithm is an example of a line index search with the price parameter dedicated to the Sale direction:

SearchIndexForSaleInsertion(Index, Price, Lines)
maxIndexNumber = Lines.NumberOfLines−1
FOR every index from 0 to maxIndexNumber

line = Lines[index]

IF line.price < price

Return index

ENDIF

ENDFOR

Return maxIndexNumber+1

Lines are deleted together with their index. The deletion step is shown by reference 107 in FIG. 3. in the list of lines, the line following the deleted line, if it exists, replaces the latter. The index of each of the lines following the deleted line, if any exist, is reduced by one position. The total index number of the list is reduced by one unit.

The following algorithm is an example of deleting a limit:

DeleteLimit(Index, Lines)
maxIndexNumber = Lines.NumberOfLines−1
IFI maxIndexNumber > Index
FOR every nextIndex with index at maxIndexNumber
Lines[nextIndex] = Lines[nextIndex+1]

ENDFOR

ENDIF
delete Lines[maxIndexNumber]

Line attributes are modified by selecting the line via its index for a given direction (Purchase or Sale), and then by modifying it with the new attributes supplied. The modification step is illustrated by step 108 in FIG. 3.

The following algorithm is an example of modifying the Quantity attribute of a line:
ModifyLine(Index, Lines, quantity)
   line=Lines[index]
   line.quantity=quantity

The insertion of a line, shown in a diagrammatic fashion by reference 109 in FIG. 3, includes creating a new line with the received attributes and then inserting this line in the list of lines for a given direction (Purchase or Sale). The index of each of the lines after the insertion of the new line, if any exist, increases by one position. The total index number of the list thereby increases by one unit.

The following algorithm is an example of inserting a line:

| | | | |
|---|---|---|---|
| InsertLine(Index, | Lines, | price, | quantity, |

timestamping, priceType)

NewLine.price = price
NewLine.quantity = quantity
NewLine.timestamping = timestamping
NewLine.priceType = priceType

maxIndexNumber = Lines.NumberOfLines−1
IF Index <= maxIndexNumber
FOR every nextIndex with index at maxIndexNumber
Lines[nextIndex+1] = Lines[nextIndex]

ENDFOR

ENDIF
Lines[Index] = NewLine

The index and update data are transmitted to the client workstation according to step 110 depicted in FIG. 3.

When the distribution server 2 retransmits the stock market data to the clients 3a, 3b, 3C, the emission of the update data comprises, in addition to stock market data, the index of the line to which the action refers. In this way, client workstations can skip steps 102 and 104 to 106, and be dedicated exclusively to steps 107 to 109. This invention therefore results in optimised client treatment.

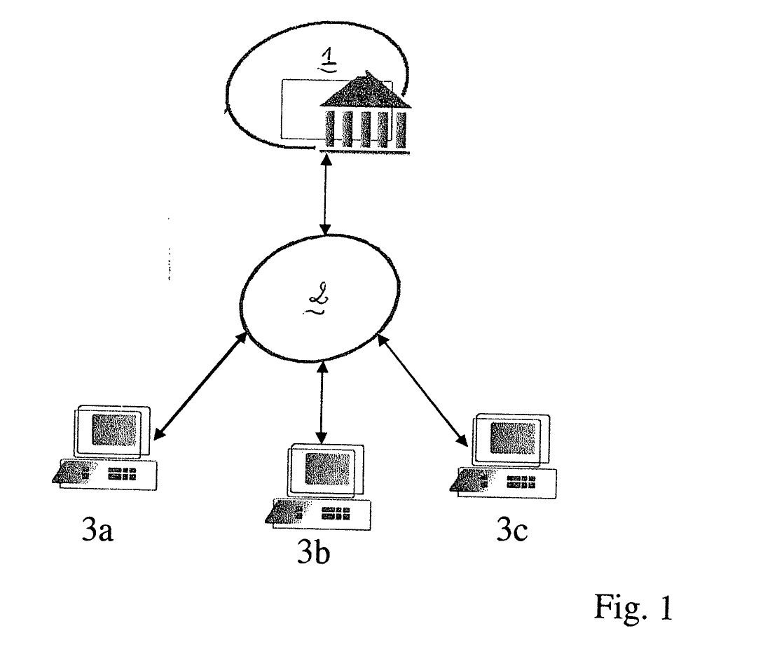

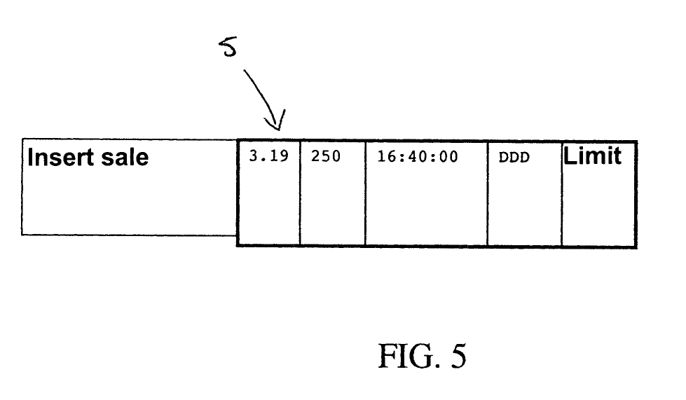

The following is an example of transmitting updated data in the original order book as shown in FIG. 1. For this, it is assumed that the update data 5 received by the distribution server 2 are those shown in FIG. 5. According to the invention, these insertion update data are then compared with the sales order book of FIG. 1. From this it is possible to deduce that these data must be inserted in line 2 of the sales order book. Information regarding inserting a price of 3.19 in line 2 of the sales order book, is then transmitted to the client workstations.

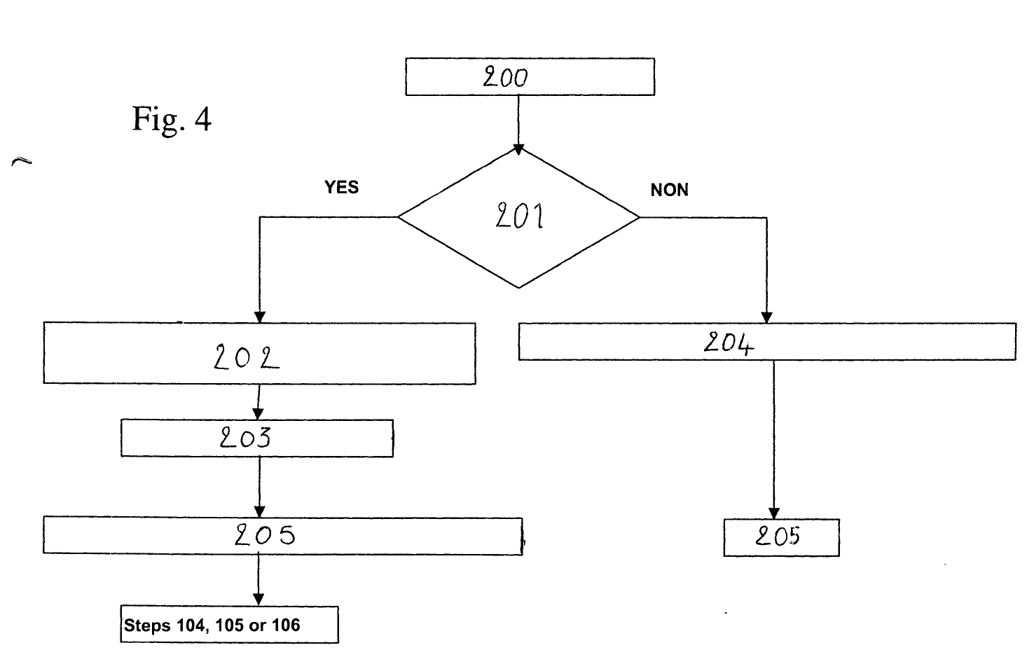

As shown in FIG. 4, according to a second embodiment of the invention, a complete photograph of the order book is received from the stock market (all the Purchase and Sale lines). This step of receiving the order book is depicted by reference 200. This form of update is a stock market operation by image.

The updated data is processed differently if original data exist in the price distribution server database. In addition, it is advisable to check according to step 201 that the original book exists.

If it does not exist, a general deletion order is issued to the client workstations according to the step bearing reference 204 in FIG. 4. An update 205 is then carried out.

This method has the aim of defining a series of actions (creation, modification, deletion). When applied to the original data, these actions make it possible to form the updated order book according to step 205 (FIG. 4). All of the actions grouped together in a very specific order constitute the updated data.

The lines in the original book and in the received book are compared according to step 202. The two order books are compared respectively for the so-called purchase lines and for the so-called sale lines. The purchase lines of the original data are compared with the purchase lines of the updated data. The same applies to sales.

The lines are compared with their matching index. After comparison, an action constituting future updated data can be generated: it is therefore determined in step 203 whether an action was generated. There are four possible scenarios:

the updated line is identical to the original line. No action is generated.

the updated line is different to the original line. A modification action is then generated on the identified line (this results in a step 205).

the updated line is present but the original line is not. An insertion action is then generated on the identified line (this results in a step 205).

the original line is present but the updated line is not. A deletion action is then generated on the identified line (this results in a step 205).

The following algorithm is an example of comparing a line:

CompareOneLine(NewLine, OldLine)
SI NewLine.Price != OldLine.Price

Return DIFFERENT ;

ENDIF
IF NewLine.Quantity = = OldLine.Quantity AND

NewLine.Timestamping = = OldLine.Timestamping
Return IDENTICAL

END IF
Return DIFFERENT

The comparison is carried out in two stages for a notion of optimisation. A first test is only comparing the price of the limits. If this comparison turns out to be positive, all the attributes that make up the limits will be compared.

The following algorithm is an example of comparing Limits for generating actions:

CompareLines(ListActions, NewLines, OldLines)
IF NewLines.LineNumber > OldLines.LineNumber

commonIndex = NewLines.LineNumber−1

ENDIF
IFNOT

commonIndex = OldLines.LineNumber−1

| ENDIF | |
|---|---|
| FOR every nextIndex from 0 to commonIndex | |
| IF CompareOneLine(NewLines[i], OldLine[i]) | |
| = = DIFFERENT | |
| ListActions.Add(nextIndex, | MODIFICATION, |

NewLines.Quantity, ...)

ENDIF

ENDFOR

IF NewLines.LineNumber > OldLines.LineNumber
FOR every nextIndex with commonIndex +1 to
NewLines.LineNumber−1
ListActions.Add(nextIndex, INSERTION, NewLines)
ENDIF
IFNOT
FOR every nextIndex with commonIndex +1 to
OldLines.LineNumber−1
ListActions.Add(nextIndex, DELETION)
ENDIF

If no action is generated, the original data are strictly identical to the updated data. In this case, no update information is sent to the client applications, since no data needs to be updated. The original data are no longer updated.

If no original data is present, the action of deleting the entire book is then sent to the client applications. At this stage, we are certain that the client applications have an order book that is identical to that of the server.

The original data (present or not) are then replaced with the updated data.

The updated data sent to the client applications result from the comparison phase or step 202. These data can comprise actions such as insertion, deletion or modification. These updated data result from the comparison between the received image of the order book and the original order book. Each of these actions is optimised because the line index is supplied. These client applications, as in the previously described embodiment of the invention, are dedicated exclusively to steps 107 to 109. As in the preceding embodiment of the invention, the indexes of the lines to be inserted, deleted or modified determined at the time of comparing the lines, are transmitted to the client workstations.

If the updated data sent to the client applications comprise insertion actions only, the client applications are dedicated exclusively to step 109 of the preceding embodiment of the invention.

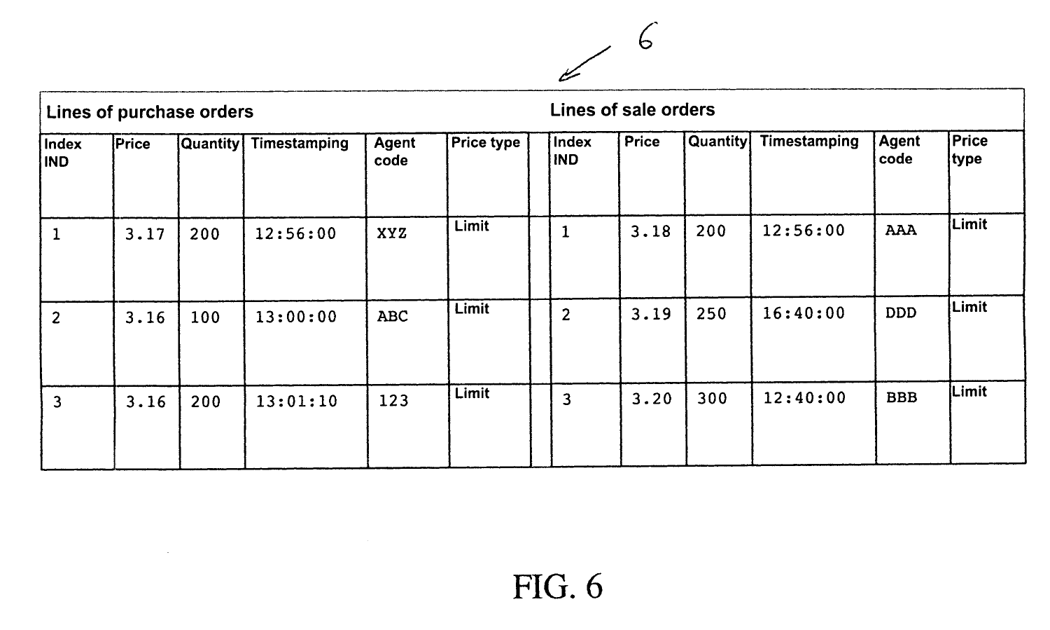

The following is an example of transmitting updated data in the original order book as shown in FIG. 1. For this reason, it is assumed that the update data 6 received by the distribution server 2 are those shown in FIG. 6. According to the invention, this update data will then be compared with the sales order book of FIG. 1. From this it can be deduced that the action associated with this updated order book corresponds to an insertion in line 2 of the sales order book for a price of 3.19. The information relating to the insertion of a price of 3.19 in line 2 of the sales order book is then simply sent to the client workstations.

1. A method of remotely updating an original order book comprising order data indexed according to at least one parameter stored in a distribution server, the method comprising the steps of:
receiving update data by said distribution server, said update data comprising at least one attribute of said at least one parameter;
comparing said update data with at least part of said original order book;
identifying, according to said comparison, of at least one index of said at least one attribute of said update data, as well as a first action relating to said original order book at said index level;
transmitting said index to at least one client workstation as well as said first action relating to said original order book at said index level.

2. A method according to claim 1, wherein said first action is identified from among actions of deletion, insertion or modification in said original order book.

3. A method according to claim 1, wherein said updated data comprise at least one data element relating to a second update action associated with said at least one parameter, said first action relating to said original order book at said index level being identical to said second action.

4. Method according to claim 1, wherein said update data comprise an updated order book, said first action relating to said original order book at said index level being determined by the difference between said updated order book and said original order book.

5. Method according to claim 1, wherein said order book is a table of data indexed in lines or columns according to at least one parameter.

6. A computer program product embodied on a computer-readable medium having computer-executable instructions for remotely updating an original order book, the order book comprising order data indexed according to at least one parameter stored in a distribution server, causing the execution of the steps of:
receiving update data by said distribution server, said update data comprising at least one attribute of said at least one parameter;
comparing said update data with at least part of said original order book;
identifying, according to said comparison, of at least one index of said at least one attribute of said update data, as well as a first action relating to said original order book at said index level;
transmitting said index to at least one client workstation as well as said first action relating to said original order book at said index level.

7. A computer program product according to claim 6, wherein said first action is identified from among actions of deletion, insertion or modification in said original order book.

8. A computer program product according to claim 6, wherein said updated data comprise at least one data element relating to a second update action associated with said at least one parameter, said first action relating to said original order book at said index level being identical to said second action.

9. A computer program product according to claim 6, wherein said update data comprise an updated order book, said first action relating to said original order book at said index level being determined by the difference between said updated order book and said original order book.

10. A computer program product according to claim 6, wherein said order book is a table of data indexed in lines or columns according to at least one parameter.

11. A system for remotely updating an original order book, the order book comprising order data indexed according to at least one parameter stored in a distribution server, the system comprising:
means for receiving update data by said distribution server, said update data comprising at least one attribute of said at least one parameter;
means for comparing said update data with at least part of said original order book;
means for identifying, according to said comparison, of at least one index of said at least one attribute of said update data, as well as a first action relating to said original order book at said index level;
means for transmitting said index to at least one client workstation as well as said first action relating to said original order book at said index level.

12. A system according to claim 11, wherein said first action is identified from among actions of deletion, insertion or modification in said original order book.

13. A system according to claim 11, wherein said updated data comprise at least one data element relating to a second update action associated with said at least one parameter, said first action relating to said original order book at said index level being identical to said second action.

14. A system according to claim 11, wherein said update data comprise an updated order book, said first action relating to said original order book at said index level being determined by the difference between said updated order book and said original order book.

15. A system according to claim 11, wherein said order book is a table of data indexed in lines or columns according to at least one parameter.
